(19) United States
(12) Patent Application Publication
(10) Pub. No.: US 2026/0307943 A1
(43) Pub. Date: Oct. 8, 2026

(54) AN AIRFLOW CONTROLLER IN A PNEUMATIC VACUUM ELEVATOR AND A METHOD TO OPERATE THE SAME

(71) Applicant: RUPHAVATHY VISHAL, CHENNAI (IN)

(72) Inventor: RUPHAVATHY VISHAL, CHENNAI (IN)

(21) Appl. No.: 18/293,372

(22) PCT Filed: Jan. 25, 2024
(86) PCT No.: PCT/IB2024/050693

§ 371 Date: Jan. 30, 2024

(30) Foreign Application Priority Data
Nov. 27, 2023 (IN) 202341080398
Jan. 25, 2024 (WO) PCT/IB2024/050693

(51) Int. Cl. B66B 9/04; B66B 11/04

(52) U.S. Cl. CPC B66B 9/04; B66B 11/0423

(57) ABSTRACT

An airflow controller 100 in a pneumatic vacuum elevator is disclosed. The airflow controller includes a bottom portion 102 and an upper portion 110. The bottom portion is adapted as a hollow stepped cylindrical structure 104 and includes a plurality of plates 108 disposed on a bottom surface of the hollow stepped cylindrical structure. The upper portion includes a cylindrical protrusion 112 configured substantially at a centre portion of the top portion with a projection on an outer face of the cylindrical protrusion, a metal plate 114 incorporated by the upper portion, and a disc 116 including a hollow circular structure 118 with an upper face 116a and a bottom face 116b and includes a plurality of extensions 120 positioned on the upper face at predetermined positions and a solenoid valve 122 accommodated by the hollow circular structure 118 and configured to open based on a timer.

### CROSS-REFERENCE TO RELATED APPLICATION

This Application claims priority from a Complete Patent application filed in India having Patent Application No. 202341080398, filed on Nov. 27, 2023, and titled “AN AIRFLOW CONTROLLER IN A PNEUMATIC VACUUM ELEVATOR AND A METHOD TO OPERATE THE SAME” and a PCT Application No. PCT/IB2024/050693 filed on Jan. 25, 2024, and titled “AN AIRFLOW CONTROLLER IN A PNEUMATIC VACUUM ELEVATOR AND A METHOD TO OPERATE THE SAME.”

### FIELD OF INVENTION

Embodiments of the present disclosure relate to elevators and more particularly to an airflow controller in a pneumatic vacuum elevator and a method to operate the same.

### BACKGROUND

The development of elevators was led by the need for the movement of heavy materials and lifting goods. The elevators provide easy transportation and are time-saving technology. Also, the elevators provide space-saving designs, enhanced security and are useful in emergency situations. Several types of elevators are available such as pneumatic elevator systems, vacuum elevator systems, and the like.

The pneumatic vacuum elevators use air pressure to cause the motion of the cabin within a tubular cylinder. The air is used as a working fluid upon the confines of the cabin. Typically, many valves have been designed for controlling the flow of air to and from chambers in order to move an elevator cabin down in the tubular pathway. However, such conventional valves absorb tremendous amount of power in their operation. Also, the conventional air valves for activation during safely measurement are unable to allow the flow of air through the orifice in order to achieve a cabin's descending speed. Further, the current system uses the air controls utilised to move the pneumatic type of elevator which require large amount of power. More specifically, the existing pneumatic valve does not have effective control of the flow of air to and from chambers in-order to move an elevator cabin (CAR) assembly down its circular flattened pathway.

Hence, there is a need for an airflow controller in a pneumatic vacuum elevator and a method to operate the same to address the aforementioned issue(s).

### OBJECTIVE OF THE INVENTION

An objective of the present invention is to provide an improved airflow controller to move a pneumatic type of elevator with reduced vibration or jerk movement.

Another objective of the present invention is to provide the airflow controller for controlling the flow of air to and from the chambers in-order to move an elevator cabin (CAR) assembly down its circular flattened pathway.

Further, an objective of the present invention is to provide the airflow controller which requires less power consumption.

### BRIEF DESCRIPTION

In accordance with an embodiment of the present disclosure, an airflow controller for controlling airflow in a pneumatic vacuum elevator is provided. The airflow controller includes a bottom portion and a top portion. The bottom portion is adapted as a hollow stepped cylindrical structure. The diameter of a top part of the stepped cylindrical structure is greater than the diameter of the bottom portion of the stepped cylindrical structure. The bottom portion includes a plurality of plates disposed at a plurality of predetermined positions on a bottom surface of the stepped structure to accommodate a plurality of fasteners. The top portion is connected with the bottom portion. The top portion includes a cylindrical protrusion, a metal plate, and a disc. The cylindrical protrusion is configured substantially at a centre portion of the top portion with a projection on an outer face of the cylindrical protrusion, wherein the projection is in a cylindrical shape. The metal plate attached to the top portion. The disc includes a hollow circular structure with an upper face and a bottom face. A diameter of the bottom face is adapted to accommodate the upper face. The disc includes a plurality of extensions and a solenoid valve. The plurality of extensions positioned on the upper face at predetermined positions on the disc. The solenoid valve accommodated by the hollow circular structure and configured to open based on a timer disposed on a panel circuit board thereby controlling speed of an elevator cabin during landing.

In accordance with another embodiment of the present disclosure, a method for assembling the airflow controller for controlling airflow in a pneumatic vacuum elevator is provided. The method includes providing, a bottom portion adapted as a hollow stepped cylindrical structure, wherein the diameter of a top part of the stepped cylindrical structure is greater than the diameter of the bottom portion of the stepped cylindrical structure. The method also includes disposing, a plurality of plates at a plurality of predetermined positions on a bottom surface of the stepped structure to accommodate a plurality of fasteners. Further, the method includes providing, a cylindrical protrusion configured substantially at a centre portion of the top portion with a projection on an outer face of the cylindrical protrusion, wherein the projection is in a cylindrical shape. Furthermore, the method includes attaching, a metal plate to the top portion. Furthermore, the method includes providing, a hollow circular structure on a disc with an upper face and a bottom face, wherein a diameter of the bottom face is adapted to accommodate the upper face. Furthermore, the method includes positioning, a plurality of extensions on the upper face of the disc at predetermined positions on the disc. Furthermore, the method includes accommodating, a solenoid valve by the hollow circular structure and configured to open based on a timer disposed on a panel circuit board thereby controlling speed of an elevator cabin during landing.

In accordance with yet another embodiment of the present disclosure, a pneumatic vacuum is provided. The elevator includes an external cylinder assembly includes an elevator cabin inserted therein. The external cylinder assembly includes a plurality of cylinders coupled using a base ring assembly and a band ring assembly. The external cylinder assembly includes a guide rail pillar mechanically coupled to the elevator cabin. The guide rail pillar is disposed at the external cylinder assembly. The guide rail pillar is configured to guide an actuation of the elevator cabin. The elevator also includes a polycarbonate sheet is configured to cover the external cylinder assembly. The polycarbonate sheet and the external cylinder assembly is coupled using a first locking device and a second locking device. The first locking device is configured to lock an air gap between the polycarbonate sheet, the base ring assembly, and the external cylinder assembly, and the second locking device is configured to lock the air gap between the polycarbonate sheet and the guide rail pillar. The elevator also includes a seal assembly adapted to fit over a top portion of the elevator cabin. The seal assembly is configured to seal the elevator cabin to reduce vibrations during the upward and downward movement of the elevator cabin. The seal assembly includes a depressurizing system configured to prevent the elevator cabin from coming into force contact with the external cylinder assembly during upward movement and contribute to safety of an elevator operation. Further, the elevator also includes an airflow controller for controlling airflow in pneumatic vacuum elevator. The airflow controller includes a bottom portion and a top portion. The bottom portion is adapted as a hollow stepped cylindrical structure. The diameter of a top part of the stepped cylindrical structure is greater than the diameter of the bottom portion of the stepped cylindrical structure. The bottom portion includes a plurality of plates disposed at a plurality of predetermined positions on a bottom surface of the stepped structure to accommodate a plurality of fasteners. The top portion is connected with the bottom portion. The top portion includes a cylindrical protrusion, a metal plate, and a disc. The cylindrical protrusion is configured substantially at a centre portion of the top portion with a projection on an outer face of the cylindrical protrusion, wherein the projection is in a cylindrical shape. The metal plate attached to the top portion. The disc includes a hollow circular structure with an upper face and a bottom face. A diameter of the bottom face is adapted to accommodate the upper face. The disc includes a plurality of extensions and a solenoid valve. The plurality of extensions positioned on the upper face at predetermined positions on the disc. The solenoid valve accommodated by the hollow circular structure and configured to open based on a timer disposed on a panel circuit board thereby controlling speed of an elevator cabin during landing.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is an exploded view of an airflow controller in accordance with an embodiment of the present disclosure;

FIG. 2a is a schematic representation of a top view of the airflow controller of FIG. 1 in accordance with an embodiment of the present disclosure;

FIG. 2b is a schematic representation of an isometric view of the airflow controller of FIG. 1 in accordance with an embodiment of the present disclosure;

FIG. 2c is a schematic representation of a front sectional view of the airflow controller of FIG. 1 in accordance with an embodiment of the present disclosure;

FIG. 2d is a schematic representation of a lateral sectional view of the airflow controller of FIG. 1 in accordance with an embodiment of the present disclosure;

FIG. 3a is a schematic representation of a cross sectional view of the of the airflow controller for a closed solenoid valve of FIG. 1 in accordance with an embodiment of the present disclosure;

FIG. 3b is a schematic representation of a cross sectional view of the of the airflow controller for an opened solenoid valve of FIG. 1 in accordance with an embodiment of the present disclosure;

FIG. 4 is a schematic representation of a pneumatic vacuum elevator in accordance with an embodiment of the present disclosure; and

FIG. 5 is a flow chart representing the steps involved in a method for assembling an airflow controller in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to an airflow controller for controlling airflow in a pneumatic vacuum elevator is provided. The airflow controller includes a bottom portion and a top portion. The bottom portion is adapted as a hollow stepped cylindrical structure. The diameter of a top part of the stepped cylindrical structure is greater than the diameter of the bottom portion of the stepped cylindrical structure. The bottom portion includes a plurality of plates disposed at a plurality of predetermined positions on a bottom surface of the stepped structure to accommodate a plurality of fasteners. The top portion is connected with the bottom portion. The top portion includes a cylindrical protrusion, a metal plate, and a disc. The cylindrical protrusion is configured substantially at a centre portion of the top portion with a projection on an outer face of the cylindrical protrusion, wherein the projection is in a cylindrical shape. The metal plate attached to the top portion. The disc includes a hollow circular structure with an upper face and a bottom face. A diameter of the bottom face is adapted to accommodate the upper face. The disc includes a plurality of extensions and a solenoid valve. The plurality of extensions positioned on the upper face at predetermined positions on the disc. The solenoid valve accommodated by the hollow circular structure and configured to open based on a timer disposed on a panel circuit board thereby controlling speed of an elevator cabin during landing.

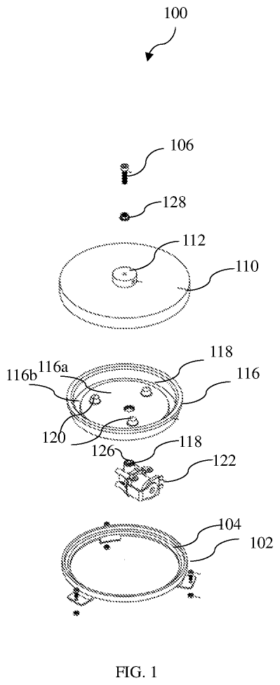

FIG. 1 is a block diagram representation of an exploded view of an airflow controller 100 for controlling airflow in a pneumatic vacuum elevator 200. The airflow controller includes a bottom portion 102, an upper portion 110, a disc 116, and a solenoid valve 122.

The bottom portion 102 is adapted as a hollow stepped cylindrical structure 104. The diameter of a top part of the hollow stepped cylindrical structure 104 is greater than the diameter of the bottom portion 102 of the hollow stepped cylindrical structure 104 to accommodate a plurality of plates 108. The bottom portion 102 includes a plurality of plates (not shown in FIG. 1) disposed at a plurality of predetermined positions on a bottom surface of the hollow stepped cylindrical structure 104 to accommodate a plurality of fasteners.

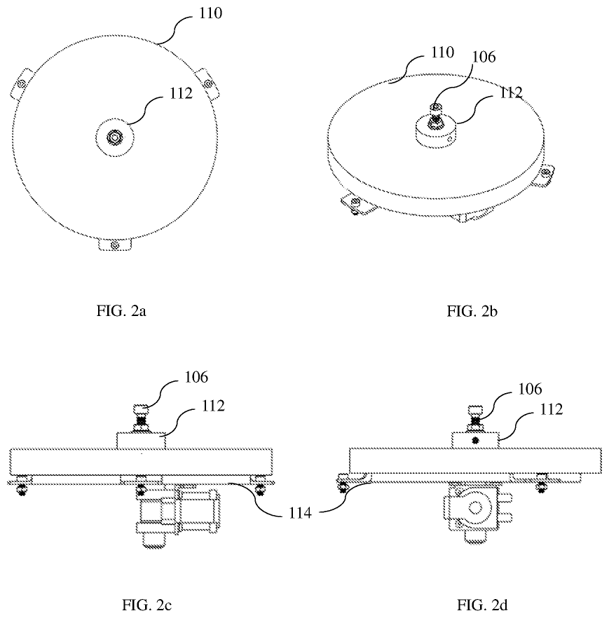

The upper portion 110 is connected with the bottom portion 102. In one embodiment, the upper portion 110 is disposed on the bottom portion 102 using a first adhesive. The upper portion 110 includes a cylindrical protrusion 112 and a metal plate 114 (shown in FIG. 2c). The cylindrical protrusion 112 is configured substantially at a centre portion of the upper portion 110 with a screw 106 projected on an outer face of the cylindrical protrusion 112 by means of a nut 128. The metal plate 114 is integrated with the upper portion 110. In one embodiment, the screw 106 is an Allen screw.

The disc 116 includes a hollow circular structure 118. Further, the disc 116 includes an upper face 116a and a bottom face 116b. A diameter of the bottom face 116b is adapted to accommodate the upper face 116a. The disc 116 includes a plurality of extensions 120 positioned on the upper face 116a and at predetermined positions on the disc 116. In one embodiment, the disc 116 is disposed in the cylindrical protrusion 112 via a second adhesive. In one embodiment, the upper face 116a is adapted to expand, and compress based on the air flow.

The solenoid valve 122 is accommodated by the hollow circular structure 118 of the disc 116 and adapted to open based on a timer disposed on a panel circuit board thereby controlling speed of an elevator cabin 220 during landing. In one embodiment, the hollow circular structure 118 includes a through hole 126 with an internal thread wherein the through hole 126 is adapted to accommodate the disc 116. In one embodiment, the solenoid valve 122 is adapted to open based on a timer configured on a panel circuit board.

FIG. 2a is a schematic representation of a top view of the airflow controller of FIG. 1 in accordance with an embodiment of the present disclosure, FIG. 2b is a schematic representation of an isometric view of the airflow controller of FIG. 1 in accordance with an embodiment of the present disclosure, FIG. 2c is a schematic representation of a front view of the airflow controller of FIG. 1 in accordance with an embodiment of the present disclosure, and FIG. 2d is a schematic representation of a lateral view of the airflow controller of FIG. 1 in accordance with an embodiment of the present disclosure. In one embodiment, the air flow controller is in fixed position. In another embodiment, the airflow controller is connected with an integrated unit at top of the elevator cylinder.

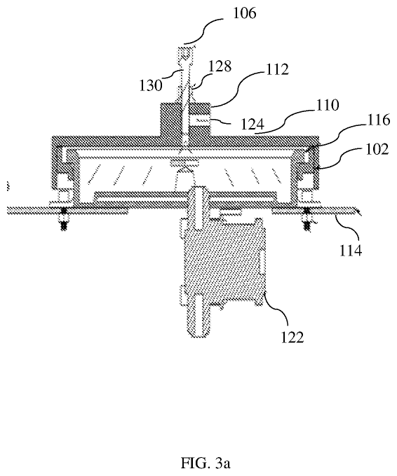

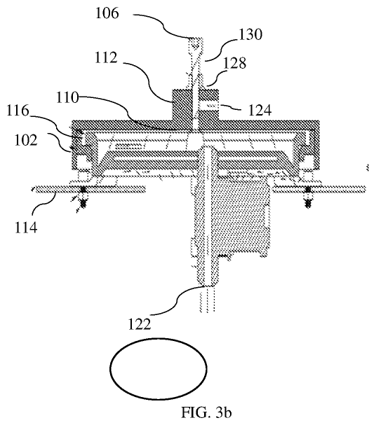

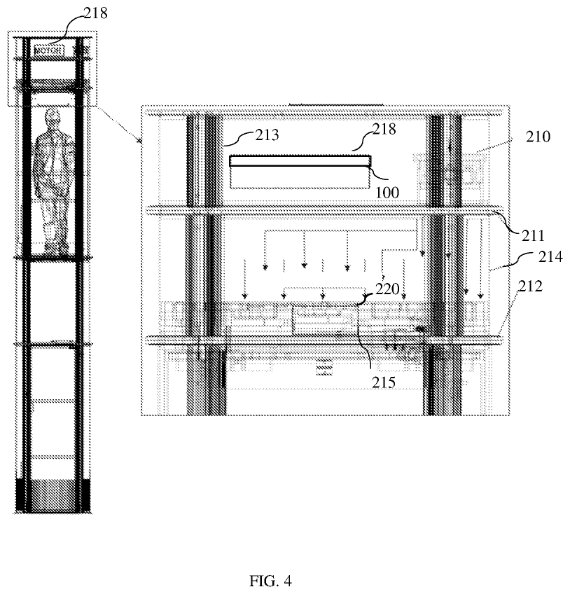

FIG. 3a is a schematic representation of a cross sectional view of the of the airflow controller for a closed solenoid valve 122 of FIG. 1 in accordance with an embodiment of the present disclosure. In one embodiment, the disc 116 is placed with top portion to bottom surface of the upper portion 110 with the use of special adhesives. The metal plate 114 is placed inbuilt with the upper portion 110 of a controller unit. In one embodiment, the metal plate 114 is a steel plate. In one embodiment, the solenoid valve 122 is attached with the disc 116. In one embodiment, the screw 106 is an Allen screw, and the nut 128 is the fixing the airflow controller to the motor unit 218 (Shown in FIG. 4). In one embodiment the size of the screw and nut 128 is M4 and M5. In one embodiment, the screw 106 includes an orifice 124 arranged on one side of the cylindrical protrusion 112. In another embodiment, the screw 106 includes a channel 130 arranged perpendicular to the orifice 124 and intersecting with the orifice 124. In embodiment, the orifice 124 is an opening, of any size or shape, in the cylindrical protrusion 112 through which the air is discharged. When the solenoid valve 122 is closed the disc is worked as normal air flow condition. In another aspect, the air flow does not allow to enter via bottom portion 102 of airflow controller from the outside of airflow controller. If does not allow the air flow to controller unit, the cabin does not move in the downward direction. The top portion is positioned on top of the airflow controller with assembled on Allen screw & Hex flange lock nut which is regulating the speed of the cabin.

FIG. 3b is a schematic representation of a cross sectional view of the of the airflow controller for an opened solenoid valve 122 of FIG. 1 in accordance with an embodiment of the present disclosure. The two portions that is bottom portion 102 and the upper portion 110 are assembled together as shown with the use of special adhesives. In one embodiment, the solenoid valve 122 is opened based on the timer which is located on the panel circuit board. The main functions of solenoid valve 122 is to vary the speed control for elevator cabin movements at landing positions.

FIG. 4 is a schematic representation of a pneumatic vacuum elevator 200 in accordance with an embodiment of the present disclosure. The pneumatic vacuum elevator 200 includes an external cylinder assembly 210 including an elevator cabin 220 inserted therein. The external cylinder assembly 210 includes a plurality of cylinders coupled using a base ring assembly 211 and a band ring assembly 212.

The pneumatic vacuum elevator 200 also includes a guide rail pillar 213 and a polycarbonate sheet 214. The guide rail pillar 213 is mechanically coupled to the elevator cabin 220. The guide rail pillar 213 is disposed at the external cylinder assembly 210, wherein the guide rail pillar 213 is configured to guide an actuation of the elevator cabin 220. The polycarbonate sheet 214 is configured to cover the external cylinder assembly 210, wherein the polycarbonate sheet 214 and the external cylinder assembly 210 is coupled using a first locking device and a second locking device. The first locking device is configured to lock an air gap between the polycarbonate sheet 214, the base ring assembly 211 and the external cylinder assembly 210 and the second locking device is configured to lock air gap between the polycarbonate sheet 214 and the guide rail pillar 213.

Further, the pneumatic vacuum elevator 200 includes a seal assembly 215 adapted to fit over a top portion of the elevator cabin 220. The seal assembly 315 is configured to seal the elevator cabin 220 to reduce vibrations during upward and downward movement of the elevator cabin 220. The seal assembly 215 includes a depressurizing system configured to prevent the elevator cabin 220 from coming into force contact with the external cylinder assembly during upward movement and contribute to safety of an elevator 200 operation.

Furthermore, the pneumatic vacuum elevator 200 includes an airflow controller located on top of the elevator cabin 220 and adapted to allow air flow from a motor unit 218 into the elevator cabin 220. The airflow controller 100 includes a bottom portion 102, an upper portion 110, a disc 116, and a solenoid valve 122.

The bottom portion 102 is adapted as a hollow stepped cylindrical structure 104. The diameter of a top part of the hollow stepped cylindrical structure 104 is greater than the diameter of the bottom portion 102 of the hollow stepped cylindrical structure 104. The bottom portion 102 includes a plurality of plates 108 disposed at a plurality of predetermined positions on a bottom surface of the hollow stepped cylindrical structure 104 to accommodate a plurality of fasteners.

The upper portion 110 is connected with the bottom portion 102. The upper portion 110 includes a cylindrical protrusion 112 and a metal plate 114. The cylindrical protrusion 112 is configured substantially at a centre portion of the top portion with a screw 106 projected on an outer face of the cylindrical protrusion 112. The metal plate 114 is incorporated by the upper portion 110.

The disc 116 includes a hollow circular structure 118 with an upper face 116a and a bottom face 116b. A diameter of the bottom face 116b is adapted to accommodate the upper face 116a. The disc 116 includes a plurality of extensions 120 positioned on the upper face 116a at predetermined positions on the disc 116.

The solenoid valve 122 is accommodated by the hollow circular structure 118 of the disc 116 and adapted to open based on a timer disposed on a panel circuit board thereby controlling speed of an elevator cabin 220 during landing.

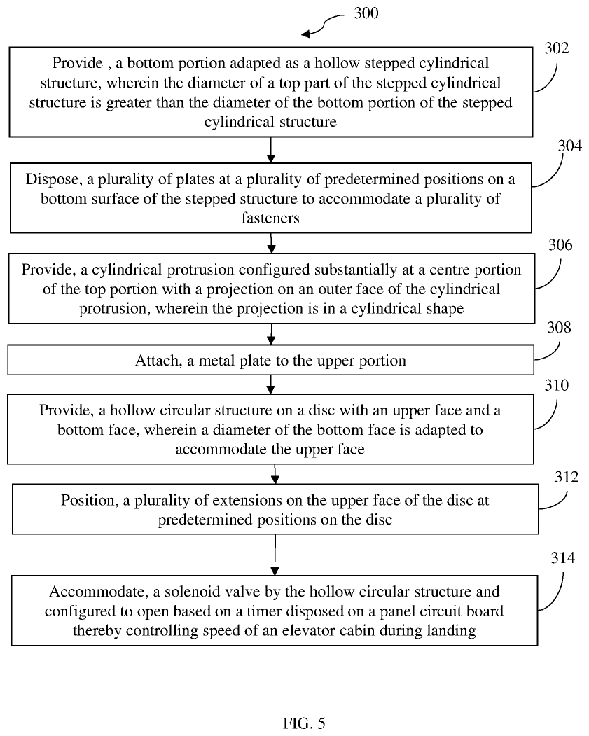

FIG. 5 is a flow chart representing the steps involved in a method 300 for assembling an airflow controller in accordance with an embodiment of the present disclosure. The method 300 includes providing, a bottom portion adapted as a hollow stepped cylindrical structure, wherein the diameter of a top part of the stepped cylindrical structure is greater than the diameter of the bottom portion of the stepped cylindrical structure in step 302.

The method 300 also includes disposing, a plurality of plates at a plurality of predetermined positions on a bottom surface of the stepped structure to accommodate a plurality of fasteners in step 304.

Further, the method 300 include providing, a cylindrical protrusion configured substantially at a centre portion of the top portion with a projection of a screw on an outer face of the cylindrical protrusion, wherein the projection is in a cylindrical shape in step 306. The method also includes arranging, an orifice arranged on one side of the cylindrical protrusion. The method includes arranging, a channel perpendicular to the orifice and intersecting with the orifice.

Furthermore, the method 300 includes attaching, a metal plate to the upper portion in step 308. In one embodiment, the metal plate is a steel plate.

Furthermore, the method 300 includes providing, a hollow circular structure on a disc with an upper face and a bottom face, wherein a diameter of the bottom face is adapted to accommodate the upper face in step 310. The method also includes disposing, the disc in the cylindrical protrusion via a second adhesive. The method also includes expanding and compressing, the upper face based on the air flow.

Furthermore, the method 300 includes positioning, a plurality of extensions on the upper face of the disc at predetermined positions on the disc in step 312.

Furthermore, the method 300 includes accommodating, a solenoid valve by the hollow circular structure and configured to open based on a timer disposed on a panel circuit board thereby controlling speed of an elevator cabin during landing in step 314. The method also includes opening, the solenoid valve based on a timer disposed on a panel circuit board.

Various embodiments of the present disclosure provides an improved airflow controller to move a pneumatic type of elevator. The airflow controller disclosed in the present disclosure provide the airflow controller for controlling the flow of air to and from the chambers in-order to move an elevator cabin (CAR) assembly down its circular flattened pathway. The air volume that enters from the motor unit to the elevator cylinder determines the rate at which the cabin may descend. The airflow controller disclosed in the present disclosure provides the orifice that lets the airflow between the outside atmosphere and disc, thereby controlling speed of an elevator cabin during landing.

Further, the arrangement of the disc and the solenoid valve of the present disclosure reduces the vibration or jerk movement due to suddenly stopping the elevator cabin while required landing position. Also, the benefit of this function is smooth landing position without any impact.

The system disclosed in the present disclosure provides energy-saving advantages which result in significant economic benefit and social benefits. The system disclosed in the present disclosure is easy to use and provides safe transportation.

Furthermore, there is no intention to be bound by any expressed or implied theory presented in the preceding technical field, background, brief summary or the detailed description. It is also to be understood that the specific devices and processes illustrated in the attached drawings, and described in the specification, are simply exemplary embodiments of the inventive concepts defined in the appended claims. Hence, specific dimensions and other physical characteristics relating to the embodiments disclosed herein are not to be considered as limiting, unless the claims expressly state otherwise.

While specific language has been used to describe the disclosure, any limitations arising on account of the same are not intended. As would be apparent to a person skilled in the art, various working modifications may be made to the method (250) in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

I claim:

1. An airflow controller 100 for controlling airflow in a pneumatic vacuum elevator comprising:
characterized in that:
a bottom portion 102 adapted as a hollow stepped cylindrical structure 104,
wherein the diameter of a top part of the hollow stepped cylindrical structure 104 is greater than the diameter of the bottom portion 102 of the hollow stepped cylindrical structure 104, and
wherein the bottom portion 102 comprises:
a plurality of plates 108 disposed at a plurality of predetermined positions on a bottom surface of the hollow stepped cylindrical structure 104 to accommodate a plurality of fasteners;
an upper portion 110 connected with the bottom portion 102, wherein the upper portion 110 comprises:
a cylindrical protrusion 112 configured substantially at a centre portion of the top portion with a projection on an outer face of the cylindrical protrusion 112, wherein the projection is in a cylindrical shape; and
a metal plate 114 attached to the upper portion 110; and
a disc 116 comprising a hollow circular structure 118 with an upper face 116a and a bottom face 116b, wherein a diameter of the bottom face 116b is adapted to accommodate the upper face 116a, wherein the disc 116 comprises:
a plurality of extensions 120 positioned on the upper face 116a at predetermined positions on the disc 116; and
a solenoid valve 122 accommodated by the hollow circular structure 118 and configured to open based on a timer disposed on a panel circuit board thereby controlling speed of an elevator cabin during landing.

2. The system 100 as claimed in claim 1, wherein the upper portion 110 is disposed on the bottom portion 102 using a first adhesive.

3. The system 100 as claimed in claim 1, wherein the projection comprises an orifice 124 arranged on one side of the cylindrical protrusion 112.

4. The system 100 as claimed in claim 2, wherein the projection comprises a channel arranged perpendicular to the orifice 124 and intersecting with the orifice 124.

5. The system 100 as claimed in claim 1, wherein the disc 116 is disposed in the cylindrical protrusion 112 via a second adhesive.

6. The system 100 as claimed in claim 1, wherein the upper face 116a is adapted to expand, and compress based on the air flow.

7. The system 100 as claimed in claim 1, wherein the hollow circular structure 118 comprises a through hole 126 with an internal thread wherein the through hole 126 is adapted to accommodate the solenoid valve 122.

8. The system 100 as claimed in claim 1, wherein the solenoid valve 122 is adapted to open based on a timer disposed on a panel circuit board.

9. A method 300 for operating the airflow controller for controlling airflow in a pneumatic vacuum elevator comprising:
providing, a bottom portion adapted as a hollow stepped cylindrical structure, wherein the diameter of a top part of the stepped cylindrical structure is greater than the diameter of the bottom portion of the stepped cylindrical structure; 302
disposing, a plurality of plates at a plurality of predetermined positions on a bottom surface of the stepped structure to accommodate a plurality of fasteners; 304
providing, a cylindrical protrusion configured substantially at a centre portion of the top portion with a projection on an outer face of the cylindrical protrusion, wherein the projection is in a cylindrical shape; 306
attaching, a metal plate to the top portion; 308
providing, a hollow circular structure on a disc with an upper face and a bottom face, wherein a diameter of the bottom face is adapted to accommodate the upper face; 310
positioning, a plurality of extensions on the upper face of the disc at predetermined positions on the disc; 312 and
accommodating, a solenoid valve by the hollow circular structure and configured to open based on a timer disposed on a panel circuit board thereby controlling speed of an elevator cabin during landing. 314

10. A pneumatic vacuum elevator 200 comprising:
an external cylinder assembly 210 comprising an elevator cabin 220 inserted therein, wherein the external cylinder assembly 210 comprises a plurality of cylinders coupled using a base ring assembly 211 and a band ring assembly 212;
a guide rail pillar 213 mechanically coupled to the elevator cabin 220, wherein the guide rail pillar 213 is disposed at the external cylinder assembly 210, wherein the guide rail pillar 213 is configured to guide an actuation of the elevator cabin 220;
a polycarbonate sheet 214 configured to cover the external cylinder assembly 210, wherein the polycarbonate sheet 214 and the external cylinder assembly 210 is coupled using a first locking device and a second locking device, wherein the first locking device is configured to lock an air gap between the polycarbonate sheet 214, the base ring assembly 211 and the external cylinder assembly 210 and the second locking device is configured to lock air gap between the polycarbonate sheet 214 and the guide rail pillar 213;
a seal assembly 215 adapted to fit over a top portion of the elevator cabin 220, wherein the seal assembly 215 is configured to seal the elevator cabin 220 to reduce vibrations during upward and downward movement of the elevator cabin 220,
wherein the seal assembly 215 comprises a depressurizing system configured to prevent the elevator cabin from coming into force contact with the external cylinder assembly during upward movement and contribute to safety of an elevator operation; and
an airflow controller 100 located on top of the external cylinder assembly 210, wherein the airflow controller 100 comprises:
a bottom portion 102 adapted as a hollow stepped cylindrical structure 104,
wherein the diameter of a top part of the hollow stepped cylindrical structure 104 is greater than the diameter of the bottom portion of the hollow stepped cylindrical structure 104, and
wherein the bottom portion 102 comprises:
a plurality of plates 108 disposed at a plurality of predetermined positions on a bottom surface of the hollow stepped cylindrical structure 104 to accommodate a plurality of fasteners;
an upper portion 110 connected with the bottom portion 102, wherein the upper portion 110 comprises:
a cylindrical protrusion 112 configured substantially at a centre portion of the top portion with a projection on an outer face of the cylindrical protrusion 112, wherein the projection is in a cylindrical shape; and
a metal plate 114 attached to the upper portion 110; and
a disc 116 comprising a hollow circular structure 118 with an upper face 116a and a bottom face 116b, wherein a diameter of the bottom face 116b is adapted to accommodate the upper face 116a, wherein the disc 116 comprises:
a plurality of extensions 120 positioned on the upper face 116a at predetermined positions on the disc 116; and
a solenoid valve 122 accommodated by the hollow circular structure 118 and configured to open based on a timer disposed on a panel circuit board thereby controlling speed of an elevator cabin during landing.
